(19) United States
(12) Patent Application Publication
(10) Pub. No.: US 2017/0052689 A1
(43) Pub. Date: Feb. 23, 2017

(54) INFORMATION PROCESSING APPARATUS, IMAGE PROCESSING APPARATUS, AND STORAGE MEDIUM

(71) Applicants: Asaki Umezawa, Tokyo (JP); Sachiko Fukumaru, Tokyo (JP); Kazuki Sasayama, Kanagawa (JP)

(72) Inventors: Asaki Umezawa, Tokyo (JP); Sachiko Fukumaru, Tokyo (JP); Kazuki Sasayama, Kanagawa (JP)

(73) Assignee: Ricoh Company, Ltd., Tokyo (JP)

(21) Appl. No.: 15/219,117

(22) Filed: Jul. 25, 2016

(30) Foreign Application Priority Data
Aug. 17, 2015 (JP) 2015160423

(51) Int. Cl. G06F 3/0484; G06F 3/0482; H04N 1/00; G06F 3/0485

(52) U.S. Cl. CPC G06F 3/04847; G06F 3/0485; G06F 3/0482; H04N 1/00482; H04N 1/00469; H04N 1/00419

(57) ABSTRACT

To improve screen operability, an information processing apparatus includes a display device, a display controller configured to display a setting screen on the display device, the setting screen including a display component corresponding to a setting item and a setting component disposed inside the display component for a purpose of setting a value of the setting item, a receiver configured to receive an operation performed on the setting screen, and an execution controller configured, in a case where the receiver receives an operation performed outside the setting component, to perform a display control of the setting screen responding to the received operation, and configured, in a case where the receiver receives an operation performed on the setting component, not to perform a display control of the setting screen responding to another operation performed outside the setting component.

### CROSS-REFERENCE TO RELATED APPLICATIONS

The present application claims the benefit of priority under 35 U.S.C. §119 of Japanese Patent Application No. 2015-160423, filed Aug. 17, 2015, the contents of which are incorporated herein by reference in their entirety.

### BACKGROUND OF THE INVENTION

1. Field of the Invention

The present disclosure relates to information processing apparatuses, image processing apparatuses, and storage media.

2. Description of the Related Art

In recent years, electronic devices having a touch panel which includes an input function and a display function have been in widespread use. In general, such electronic devices may display a setting screen in accordance with each of the setting items when performing settings.

Furthermore, on such conventional electronic devices, a user may perform settings of each of the setting items on a screen having multiple display components corresponding to each of the setting items by performing predetermined types of operations per item.

### RELATED ART DOCUMENTS

Patent Document 1: Japanese Unexamined Patent Application Publication No. 2005-229646
Patent Document 2: Japanese Patent No. 2622501

### SUMMARY OF THE INVENTION

One aspect of the present invention provides an information processing apparatus including a display device, a display controller configured to display a setting screen on the display device, the setting screen including a display component corresponding to a setting item and a setting component disposed inside the display component for a purpose of setting a value of the setting item, a receiver configured to receive an operation performed on the setting screen, and an execution controller configured, in a case where the receiver receives an operation performed outside the setting component, to perform a display control of the setting screen responding to the received operation, and configured, in a case where the receiver receives an operation performed on the setting component, not to perform a display control of the setting screen responding to another operation performed outside the setting component.

### BRIEF DESCRIPTION OF THE DRAWINGS

FIG. 1 is a drawing illustrating an example of a setting screen according to a first embodiment;

FIG. 2 is a drawing illustrating an example of a hardware configuration of an image processing apparatus according to the first embodiment;

FIG. 3 is a drawing illustrating an example of a layered structure of programs included in an operator and a body of the image processing apparatus according to the first embodiment;

FIG. 4 is a drawing for explaining functions of the operator according to the first embodiment;

FIG. 5 is a flowchart for explaining actions of the operator according to the first embodiment;

FIG. 6 is a drawing illustrating an example where a setting component is selected on the setting screen according to the first embodiment;

FIGS. 7A and 7B are drawings illustrating examples where a setting operation is performed using the setting component inside a display component according to the first embodiment;

FIGS. 8A and 8B are drawings illustrating examples where the display component is selected on the setting screen according to the first embodiment;

FIG. 9 is a drawing illustrating an example where a scrolling operation is detected on the setting screen according to the first embodiment;

FIG. 10A is a drawing illustrating a first example of a detail setting screen of a color balance;

FIG. 10B is a drawing illustrating a second example of a detail setting screen of a color adjustment;

FIG. 11 is a drawing illustrating an example of a setting screen according to a second embodiment;

FIG. 12 is a drawing for explaining the functions of an operator according to the second embodiment;

FIG. 13 is a flowchart for explaining actions of the operator according to the second embodiment;

FIG. 14 is a drawing illustrating an example where a setting component is selected on the setting screen according to the second embodiment;

FIGS. 15A through 15C are drawings illustrating examples where a setting is performed using the setting component according to the second embodiment;

FIG. 16 is a drawing illustrating an example where a scrolling operation is detected on the setting screen according to the second embodiment; and

FIG. 17 is a second drawing illustrating an example where a scrolling operation is detected on the setting screen according to the second embodiment.

### DESCRIPTION OF THE EMBODIMENTS

The conventional technology requires a user to perform such complicating operations as to go to a setting screen for setting an item. Furthermore, the types of operations performed on a touch panel include scrolling, flicking, touching, etc., which may cause erroneous operations and erroneous detections in a case where multiple display components which require different types of operations are displayed on a single screen in such a conventional manner.

The object of the present disclosure is to improve screen operability.

### First Embodiment

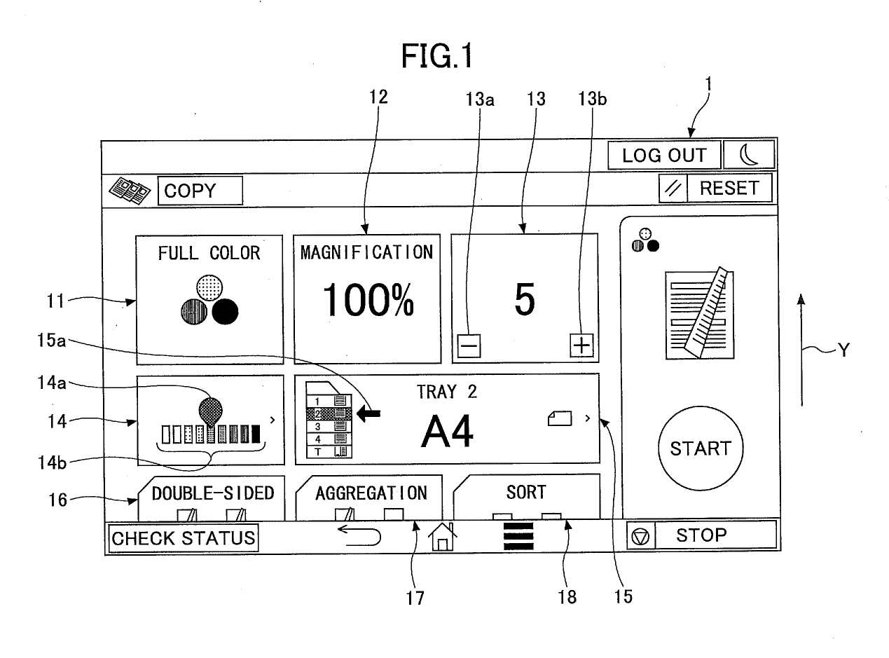

In the following, embodiments of the present invention will be described with reference to the accompanying drawings. FIG. 1 is a drawing illustrating an example of a setting screen according to the first embodiment.

A settings screen 1 illustrated in FIG. 1 is an example of a screen displayed, for example, on an operation panel of an image processing apparatus.

The setting screen 1 is a screen displayed on an operation panel including display components 11 through 18 which correspond to setting items of the image processing apparatus. On the setting screen 1 in FIG. 1, the display components 11 through 15, as well as parts of the display components 16 through 18, are displayed. The display components 16 through 18 are fully displayed when the setting screen 1 is scrolled towards a Y-arrow direction. On the setting screen 1, in response to a scrolling operation, the display components corresponding to the position of the display region of the operation panel are displayed.

First, the display components constituting the setting screen 1 will be explained.

The display component 11 is for setting the color balance. The display component 12 is for setting the magnification ratio of printed images. The display component 13 is for setting the number of copies. The display component 14 is for setting the image density. The display component 15 is for setting the sheet feeding tray to be used.

The display component 16 is for setting the double-sided printing. The display component 17 is for setting the aggregate printing. The display component 18 is for setting the sorting.

According to the first embodiment, in response to receiving a selecting instruction directed to any one of the display components, the screen transitions to a screen for detail setting (hereinafter referred to as a detail setting screen) of the item corresponding to the selected display component. Here, receiving a selecting instruction means, for example, to detect that a region displaying a display component is tapped as an operation.

Furthermore, some of the display components 11 through 18 include display components for setting (hereinafter referred to as setting components) for the use of setting the values of items corresponding to the display components.

According to the first embodiment, with regard to display components including setting components, in response to detecting that the region of a display component other than the region of a setting component is tapped as an operation, the screen transitions from the setting screen 1 to a detail setting screen of the item corresponding to the tapped display component.

According to the first embodiment, setting components 13a and 13b are displayed inside the display component 13. A setting component 14a is displayed inside the display component 14. A setting component 15a is displayed inside the display component 15.

The setting components 13a and 13b are for setting the number of print copies, which is the item corresponding to the display component 13. According to the first embodiment, for example, the value “5” displayed on the display component 13, which indicates the number of copies, increases when the setting component 13a is tapped, and decreases when the setting component 13b is tapped.

The setting component 14a is for setting the value of print density, which is the item corresponding to the display component 14. According to the first embodiment, for example, when the setting component 14a is slid in the lateral direction, the print density is set at the value in accordance with the position of the setting component 14a.

The setting component 15a is for setting the sheet feeding tray, which is the item corresponding to the display component 15. According to the first embodiment, for example, when the setting component 15a is slid in the vertical direction, the sheet feeding tray is set to be the one pointed at by the setting component 15a.

In other words, according to the first embodiment, values of setting items can be set without transitioning the screen from the setting screen 1 which includes multiple display components respectively corresponding to the setting items to a detail setting screen of the item selected for setting.

In this way, according to the first embodiment, values of setting items can be set on the setting screen 1 in a higher layer, where the setting items are overviewed through the display components.

Next, the scrolling operation of the setting screen 1 will be explained. On the setting screen 1 in the first embodiment, the scrolling operation of the setting screen 1 is restricted while a setting component is being operated.

Specifically, according to the first embodiment, the scrolling function of the setting screen 1 is invalidated while, for example, either of the setting components 13a or 13b is being tapped. Therefore, in the first embodiment, the setting screen 1 is not scrolled even in a case where a touching or flicking is detected on the region other than the displaying region of the setting components 13a and 13b while either of the setting components 13a or 13b is being operated. Furthermore, in this case, the screen does not transition from the setting screen 1 to the detail setting screen of the number of copies, which corresponds to the display component 13.

Further, according to the first embodiment, the scrolling function of the setting screen 1 is also invalidated while the setting component 14a is being slid in the lateral direction. Therefore, in the first embodiment, the setting screen 1 is not scrolled even in a case where a touching or flicking is detected on the region other than the displaying region of the setting components 14a while the setting component 14a is being operated. Furthermore, in this case, the screen does not transition from the setting screen 1 to the detail setting screen of the print density, which corresponds to the display component 14.

Similarly, according to the first embodiment, the scrolling function of the setting screen 1 is also invalidated while the setting component 15a is being slid in the vertical direction. Therefore, in the first embodiment, the setting screen 1 is not scrolled even in a case where a touching or flicking is detected on the region other than the displaying region of the setting component 15a while the setting component 15a is being operated. Furthermore, in this case, the screen does not transition from the setting screen 1 to the detail setting screen of the sheet feeding tray, which corresponds to the display component 15.

As described above, on the setting screen 1 according to the first embodiment, in a case where a setting component provided in a display component is being operated, operations other than the operation directed to the setting component are restricted. Specifically, on the setting screen 1, while a setting component is being operated, other operations such as tapping the display components and flicking or sliding the other parts of the screen, etc., are invalidated.

Therefore, according to the first embodiment, even though multiple setting components are displayed on a single screen, an erroneous operation or an erroneous detection is prevented.

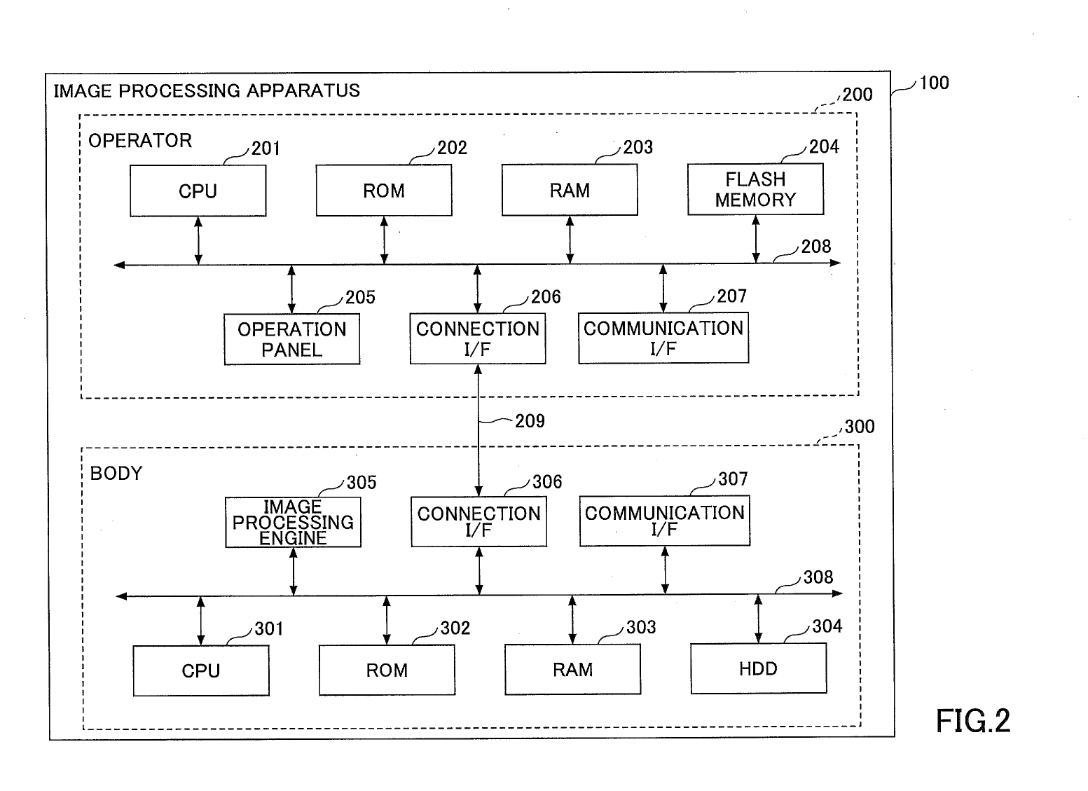

In the following, the image processing apparatus 100 which displays the setting screen 1 will be explained. FIG. 2 is a drawing illustrating an example of a hardware configuration of the image processing apparatus 100.

The image processing apparatus 100 of the first embodiment is a multi-function peripheral (MFP) having image processing functions such as a copy function, a scanner function, a facsimile function, and a print function.

As illustrated in FIG. 2, the image processing apparatus 100 includes an operator 200 and a body 300.

The operator 200 is for a user to perform various operations such as selecting an image processing function to be executed by the body 300, inputting various setting values to execute an image processing function with, inputting an execution instruction in order to start executing an image processing function, switching displayed screens, etc.

The body 300 performs various processing such as an execution of the image processing functions, in according with various operations from a user through the operator 200. Furthermore, the body 300 requests the operator 200 to display various messages.

The operator 200 of the first embodiment includes a central processing unit (CPU) 201, a read-only memory (ROM) 202, and a random access memory (RAM) 203. Furthermore, the operator 200 includes a flash memory 204, an operation panel 205, a connection interface (I/F) 206, and a communication I/F 207. The hardware devices mentioned here are connected to each other through a bus 208.

The CPU 201 is an arithmetic unit which executes various programs stored in the ROM 202 or the flash memory 204 using the RAM 203 as a work area, for entirely controlling the operator 200.

The ROM 202 is a non-volatile semiconductor memory (memory device) which is capable of storing data even when the power is off. The RAM 203 is a volatile semiconductor memory (memory device) which temporarily stores programs and data.

The flash memory 204 is a non-volatile recording medium which stores the various programs to be executed by the CPU 201, such as programs to actualize the first embodiment, and various data.

The operation panel 205, such as a touch panel, is for a user to perform the various operations. Furthermore, the operation panel 205 displays the various messages. In other words, the operation panel 205 displays, for example, a graphical user interface (GUI), which is for a user to perform various operations for various functions of the image processing apparatus 100, as well as information relating to processing results of the image processing apparatus 100, such as error messages and guidance messages.

The connection I/F 206 is an interface for connecting to the body 300 through a connecting path 209. As an example of the connection I/F 206, an interface of the universal serial bus (USB) standard may be employed.

The communication I/F 207 is an interface for communicating with other devices. As an example of the communication I/F 207, a wireless local area network (LAN) of the Wi-Fi standard may be employed.

The body 300 of the first embodiment includes a CPU 301, a ROM 302, and a RAM 303. Furthermore, the body 300 includes a hard disk drive (HDD) 304, an image processing engine 305, a connection I/F 306, and a communication I/F 307. The hardware devices mentioned here are connected to each other through a bus 308.

The CPU 301 is an arithmetic unit which executes various programs stored in the ROM 302 or the HDD 304 using the RAM 303 as a work area, for entirely controlling the body 300.

The ROM 302 is a non-volatile semiconductor memory (memory device) which is capable of storing data even when the power is off. The RAM 303 is a volatile semiconductor memory (memory device) which temporarily stores programs and data.

The HDD 304 is a non-volatile recording medium which stores the various programs to be executed by the CPU 301, such as programs to actualize the first embodiment, and various data.

The image processing engine 305 is hardware for performing image processing to actualize the image processing functions such as the copy function, the scanner function, the facsimile function, and the print function, etc.

The image processing engine 305 includes, for example, a scanner which optically reads a manuscript to generate image data, a plotter which performs printing on a sheet material such as a paper, and a facsimile communication device which performs facsimile communication. Furthermore, the information processing engine 305 may include, for example, a finisher which sorts printed sheets and an automatic document feeder (ADF) which feeds manuscripts automatically.

The connection I/F 306 is an interface for connecting to the operator 200 through the connecting path 209. As an example of the connection I/F 306, an interface of the USB standard may be provided.

The communication I/F 307 is an interface for communicating with other devices. As an example of the communication I/F 307, a wireless LAN of the Wi-Fi standard may be provided.

The image processing apparatus 100 according to the first embodiment includes such hardware configuration as described above, so as to actualize various processing as described below. Here, although the configuration of the image processing apparatus 100 including the operator 200 is exemplified in FIG. 2, the configuration is not limited to such a configuration. The operator 200 may be an information processing device such as a tablet, a smartphone, a cellular phone, and a personal digital assistant (PDA). That is to say, such information processing devices may communicate with the image processing apparatus 100 through the communication I/F 207 of the operator 200 or the communication I/F 307 of the body 300, so as to control the image processing apparatus 100.

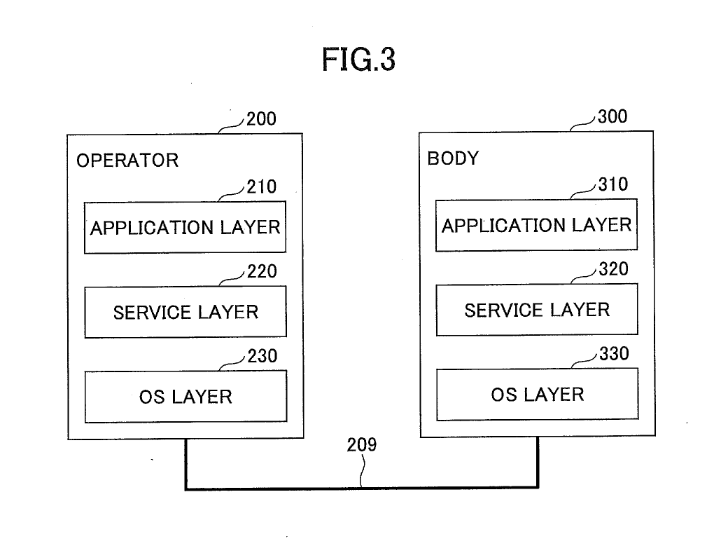

Next, a layered structure of programs included in the operator 200 and the body 300 of the image processing apparatus 100 will be explained. FIG. 3 is a drawing illustrating an example of the layered structure of programs included in the operator 200 and the body 300 of the image processing apparatus 100.

FIG. 3 illustrates the layered structure of programs included in the operator 200 and the layered structure of programs included in the body 300.

The programs included in the operator 200 are stored in the ROM 202, the flash memory 204, etc. The programs included in the body 300 are stored in the ROM 302, the HDD 304, etc.

First, the layered structure of programs included in the body 300 will be explained. The programs included in the body 300 can be roughly categorized into an application layer 310, a service layer 320, and an operating system (OS) layer 330.

The programs categorized into the application layer 310 are programs for driving hardware devices so as to actualize the image processing functions, such as a copy application, a scanner application, a facsimile application, and a print application.

The programs categorized into the service layer 320 are programs mediating the application layer 310 and the OS layer 330. The programs provide, for example, an interface for the programs of the application layer 310 to utilize the hardware devices of the body 300 and an interface for reporting the condition of the hardware devices of the body 300.

Specifically, the programs categorized into the service layer 320, for example, receive and mediate action requests directed to the hardware devices. Further, the programs of the service layer 320 send error information, which indicates errors detected in the hardware devices. Here, the action requests received by the programs of the service layer 320 include, for example, action requests for the image processing engine 305 to perform image processing such as an action request for scanning by the scanner and an action request for printing by the plotter.

Here, the programs categorized into the service layer 320 similarly provide such interfaces to the application layer 210 of the operator 200. That is to say, the programs categorized into the application layer 210 of the operator 200 can similarly drive the hardware devices of the body 300 through accessing to service layer 320, so as to actualize the image processing functions.

The program categorized into the OS layer 330 is a program for providing basic functions to control the hardware devices of the body 300, which is referred to as basic software. The program categorized into the OS layer 330 receives action requests directed to the hardware devices sent from the programs categorized into the application layer 310 through the programs categorized into the service layer 320, so as to execute processing in accordance with each of the action requests. Further, the programs categorized into the OS layer 330 receive errors detected in the hardware devices and then sends the error information to the service layer 320.

Next, the layered structure of programs included in the operator 200 will be explained. Similarly to the body 300, the programs included in the operator 200 can be roughly categorized into an application layer 210, a service layer 220, and an OS layer 230.

However, the varieties of the functions provided by the programs categorized into the application layer 210 and the action requests received by the programs categorized into the service layer 220 are different compared to the body 300. The programs categorized into the application layer 210 of the operator 200 mainly provide a user interface function for a variety of user operations and for displaying a variety of screens.

Here, in the first embodiment, each of the OSs operates independently in the operator 200 and the body 300. Further, the OSs need not be the same type as long as the operator 200 and the body 300 can mutually communicate. For example, Android (trademark) may be employed as an OS on the operator 200 whereas Linux (trademark) is employed as an OS on the body 300.

In this way, in the image processing apparatus 100, the operator 200 and the body 300 are controlled by different OSs, so that the communication between the operator 200 and the body 300 is performed as inter-devices communication between different information processing apparatuses, not as inter-process communication in a single device. The examples of the communication are the action of the operator 200 to send operation information, which indicates a received user operation, to the body 300 and the action of the body 300 to send a display request, which instructs the operator 200 to display a screen.

Here, in the image processing apparatus 100 of the first embodiment, the OSs need not be different types in the operator 200 and the body 300. Instead, the OSs may be the same type in both the operator 200 and the body 300. Furthermore, in the image processing apparatus 100 of the first embodiment, the OSs need not operate independently in each of the operator 200 and the body 300. Instead, the same OS may operate in both the operator 200 and the body 300.

In the image processing apparatus 100 of the first embodiment, the operator 200 displays the setting screen 1 (see FIG. 1) and controls the displaying of the setting screen 1.

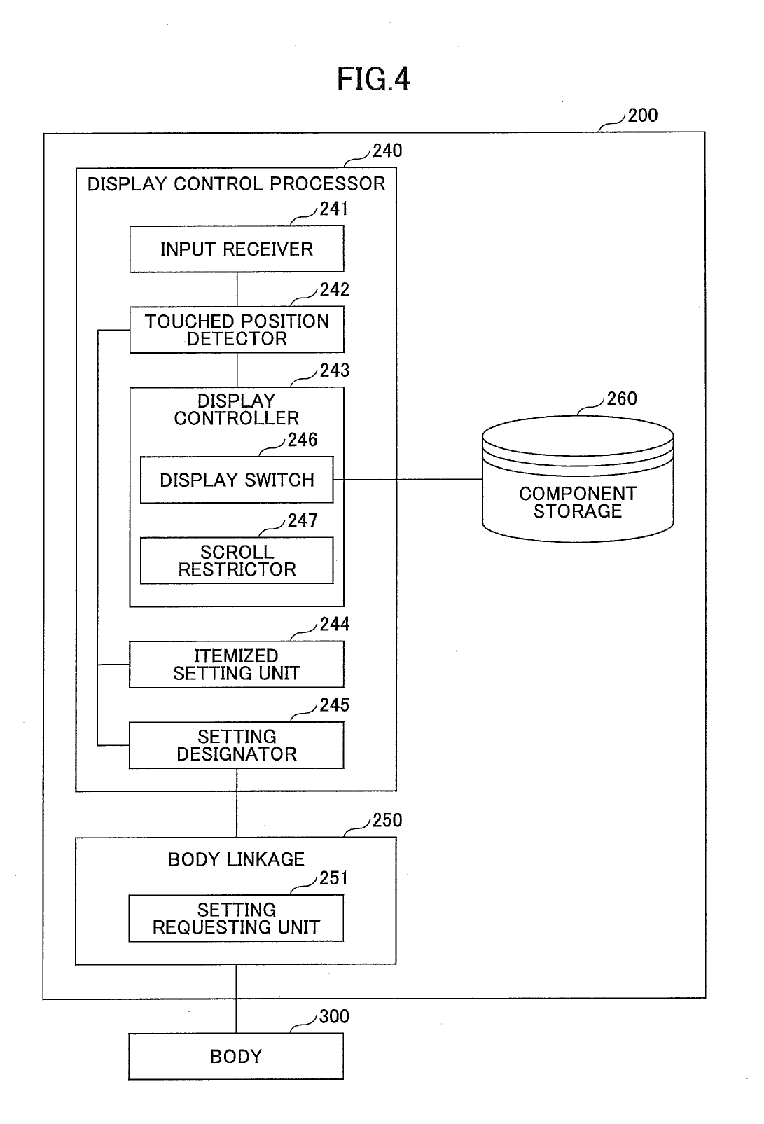

Here, the functions of the operator 200 will be explained with reference to FIG. 4. FIG. 4 is a drawing for explaining the functions of the operator 200 according to the first embodiment. Here, the CPU 201 executes the programs categorized into the application layer 210, so as to actualize each of the functions of the operator 200.

The operator 200 of the first embodiment includes a display control processor 240, a body linkage 250, and a component storage 260.

The display control processor 240 of the first embodiment receives operations entered on the operation panel 205 and performs the displaying in accordance with each of the operations. The display control processor 240 of the first embodiment mainly controls the display of the setting screen 1, which is provided for settings of the body 300, or the image processing apparatus 100.

The body linkage 250 sends execution requests of a variety of processes to the body 300, based on each of the operations entered on the operator 200.

The component storage 260 stores images of a variety of components displayed on the setting screen 1. Specifically, the component storage 260 stores images of display components and setting components corresponding to each of the setting items.

In the following, the display control processor 240 will be explained. The display control processor 240 includes an input receiver 241, a touched position detector 242, a display controller 243, an itemized setting unit 244, and a setting designator 245.

The input receiver 241 receives input entered on the operation panel 205. Specifically, the input receiver 241 determines the type of an operation entered on the operation panel 205, and then receives input in accordance with the type of the operation. The touched position detector 242 detects the position of the operation panel 205 being touched.

The display controller 243 controls the displaying of the setting screen 1 in response to detecting that a setting component is touched. The display controller 243 will be explained in detail in the following description.

The itemized setting unit 244 instructs the operation panel 205 to display an itemized detail setting screen in accordance with the position detected by the touched position detector 242. Furthermore, the itemized setting unit 244 sets the value of the corresponding item in response to an operation entered on the detail setting screen.

The setting designator 245 instructs the body linkage 250 to set the value selected on the setting screen 1 or the detail setting screen displayed on the operation panel 205.

Here is the explanation of the display controller 243: the display controller 243 of the first embodiment includes a display switch 246 and a scroll restrictor 247.

The display switch 246 enlarges a setting component displayed on the setting screen 1 responding to a detection of an operation performed on the setting component of the setting screen 1. Specifically, the display switch 246 refers to the component storage 260, so as to acquire an enlarged image of the setting component which corresponds to the respective setting component. Then, the display switch 246 hides the image of the setting component, and then displays the enlarged image of the setting component. Here, the detection of an operation means that the position detected by the touched position detector 242 matches the position where a setting component is displayed.

In the following, images of setting components and enlarged images of the setting components stored in the component storage 260 according to the first embodiment will be explained.

The component storage 260 of the first embodiment stores images of the setting components displayed on the setting screen 1 and enlarged images of the setting components in a corresponding manner. In the following explanation, the images of the setting components displayed on the setting screen 1 are referred to as standard images of setting components whereas the enlarged images of each of the setting components are referred to as enlarged images of setting components.

Specifically, in the component storage 260 of the first embodiment, a standard image and an enlarged image of the setting component 14a are stored in a corresponding manner. Further, in the component storage 260, a standard image and an enlarged image of the setting component 15a are stored in a corresponding manner.

Here, the component storage 260 of the first embodiment may store, in a corresponding manner, the standard images and the enlarged images of only the setting components on which a user performs sliding operations on the setting screen 1. In this case, with regard to the setting components 13a and 13b, only the standard images need to be stored in the component storage 260.

Here, although the display controller 243 of the first embodiment hides the standard images and then displays the enlarged images stored in the component storage 260, so as to switch the sizes of the images of the setting components, the method for switching the sizes of the images of the setting components is not limited to such a method. For example, displayed images may be enlarged responding to a detection of an operation on the setting components, without preparing enlarged images of the setting components.

The scroll restrictor 247 of the first embodiment restricts scrolling of the image on the operation panel 205 responding to a detection of an operation performed on the setting components. In other words, the scroll restrictor 247 invalidates operations of scrolling the setting screen 1 while an operation directed to the setting components is being detected.

The explanation of the display control processor 240 is as described above. Next, the body linkage 250 will be explained.

The body linkage 250 of the first embodiment includes a setting requesting unit 251. The setting requesting unit 251 receives setting instructions along with values of items from the setting designator 245, and then sends setting requests to the body 300.

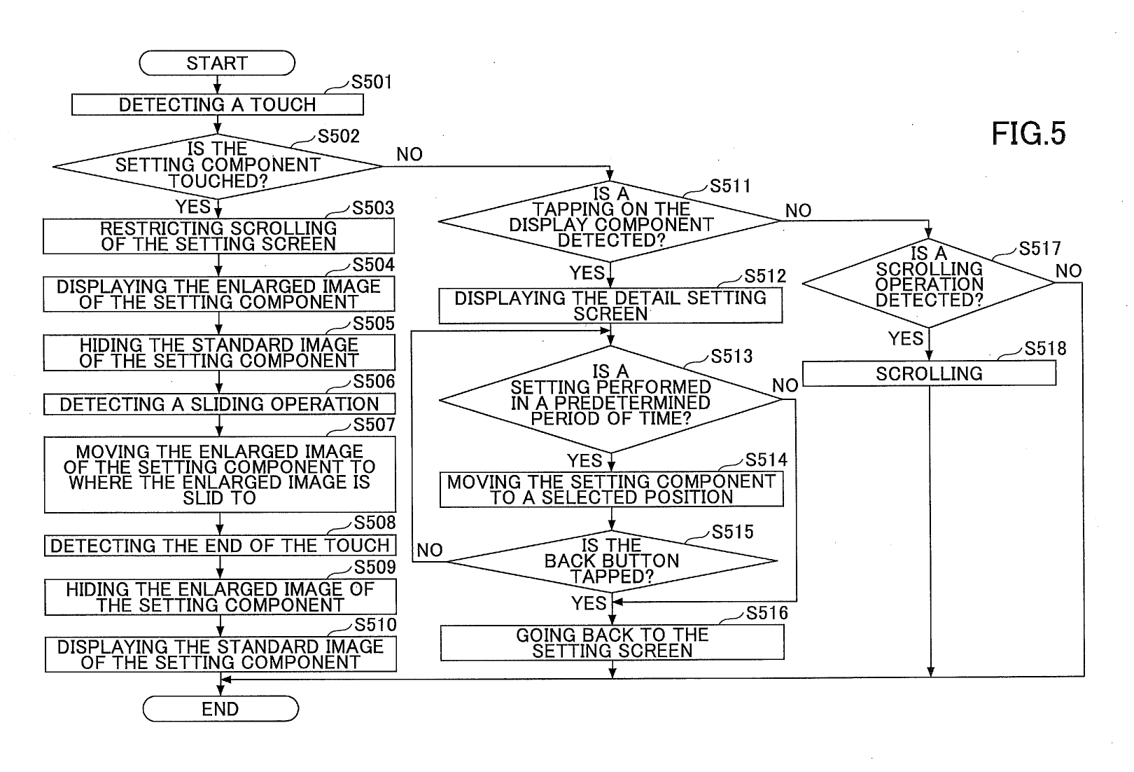

In the following, the actions of the operator 200 according to the first embodiment will be explained with reference to FIG. 5. FIG. 5 is a flowchart for explaining the actions of the operator 200 according to the first embodiment.

In the operator 200 according to the first embodiment, the input receiver 241 of the display control processor 240 receives a touching operation performed on the operation panel 205 (step S501). Subsequently, the touched position detector 242 of the display control processor 240 detects the touched position of the operation panel 205, and then determines whether the detected position matches the display positions of setting components (step S502).

In a case where the detected position matches the positions displaying setting components (YES in step S502), in other words in a case where an operation directed to a setting component is detected, the scroll restrictor 247 of the display controller 243 restricts scrolling the image of the operation panel 205 (step S503). Then, the display switch 246 of the display controller 243 displays the enlarged image of the setting component (step S504), and hides the standard image of the setting component (step S505).

Subsequently, the input receiver 241 of the display control processor 240 detects a sliding operation directed to the setting component (step S506). Here, in a case where a sliding operation directed to the setting component is not detected in a predetermined period of time, the display control processor 240 may release the scrolling restriction. In this case, the sequence returns to step S502.

In a case where a sliding operation is detected, the display controller 243 moves the display position of the enlarged image of the setting component to where the enlarged image is slid to (step S507). Here, the display controller 243 may move the enlarged image, tracking the finger of a user.

Subsequently, the input receiver 241 of the display control processor 240 finishes the detection of being touched (step S508). In other words, the input receiver 241 of the display control processor 240 detects that the finger of the user gets away from the operation panel 205.

Then, the display switch 246 of the display controller 243 hides the enlarged image (step S509), and displays the standard image (step S510), and then terminates processing.

In a case where the detected position does not match the positions displaying setting components (NO in step S502), in other words in a case where an operation directed to a setting component is not detected, the touched position detector 242 of the display control processor 240 determines whether the detected position on the operation panel 205 matches display positions of display components (step S511). In other words, the display control processor 240 determines whether an operation is performed within the region of the display components. In a case where the display control processor 240 determines that an operation is not performed within the region of the display components (NO in step S511), the sequence proceeds to step S517, which will be described later.

In a case where the display control processor 240 determines that an operation is performed within the region of the display components (YES in step S511), the itemized setting unit 244 of the display control processor 240 displays a detail setting screen of the item corresponding to the operated display component (step S512). Then, the input receiver 241 of the display control processor 240 determines whether a touching operation is performed in a predetermined period of time (step S513).

In a case where the display control processor 240 determines that a setting is not performed in the predetermined period of time (NO in step S513), the sequence proceeds to step S516, which will be described later.

In a case where the display control processor 240 determines that a setting is performed in the predetermined period of time (YES in step S513), the display control processor 240 moves the position of the setting component displayed in the detail setting component, according to an operation (step S514). The detail setting screen will be described later in detail.

Subsequently, the input receiver 241 of the display control processor 240 determined whether an operation for returning to the setting screen 1 is performed (step S515).

In a case where the operation is performed (YES in step S515), the display control processor 240 transitions the screen of the operation panel 205 from the detail setting screen to the setting screen (step S516), and then terminates processing. In a case where the operation is not performed (NO in step S515), the display control processor 240 returns to step S513.

In a case where the display control processor 240 determines that an operation is not performed within the region of the display components (NO in step S511), the input receiver 241 of the display control processor 240 determines whether a scrolling operation is detected (step S517). In a case where a scrolling operation is not detected (NO in step S517), the display control processor 240 terminates processing.

In a case where a scrolling operation is detected (YES in step S517), the display control processor 240 scrolls the image according to the operation (step S518), and then terminates processing. Here, the scrolling operation in step S517 can be detected in the region other than the setting components, such as on the display components and in the area other than the display components.

As described above, according to the first embodiment, in the case where an operation is performed on a setting component, operations for setting the values are accepted whereas scrolling operations are restricted. In the case where a scrolling operation is detected in the region other than the setting components, the screen is scrolled. Further, according to the first embodiment, in the case where an operation is performed within a display component but in the region other than the setting components, a detail setting screen for the corresponding item is displayed.

Here, the steps following step S504 in FIG. 5 describe processing in the case of operating a setting component which requires a sliding operation for setting the value. However, in the case of operating setting components which do not require a sliding operation, such as the setting components 13a and 13b, enlarged images can be displayed and standard images can be hidden only at the time of being operated.

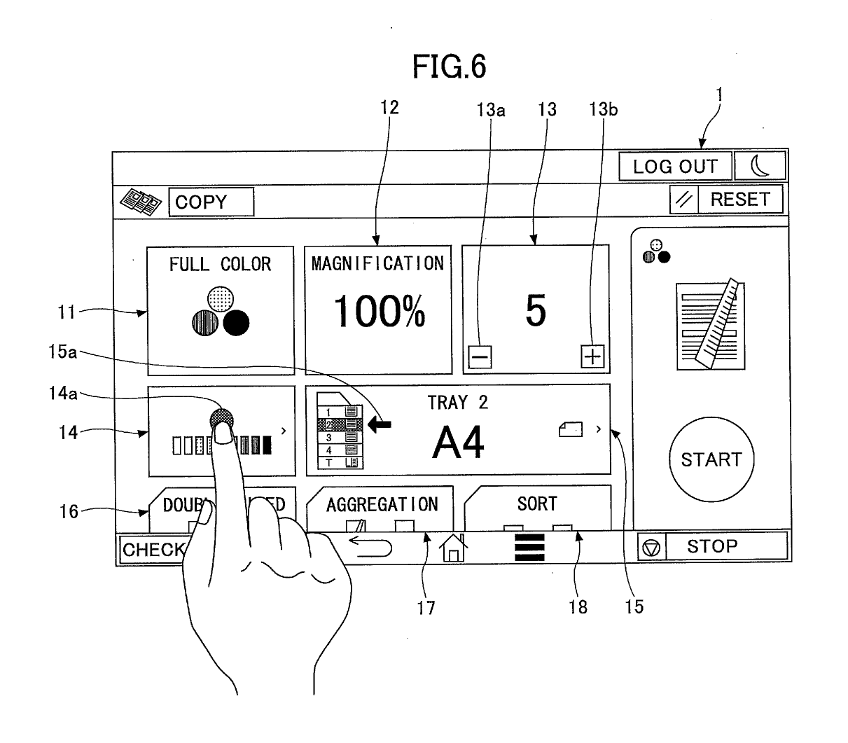

In the following, the processing illustrated in FIG. 5 will be explained more specifically, with reference to FIG. 6 through FIG. 10. FIG. 6 is a drawing illustrating an example where a setting component is being selected on the setting screen 1 according to the first embodiment.

FIG. 6 is a drawing illustrating where an operation directed to the setting component 14a is accepted. According to the first embodiment, in the case of FIG. 6, only operations directed to the setting component 14a are accepted, while scrolling operations are restricted.

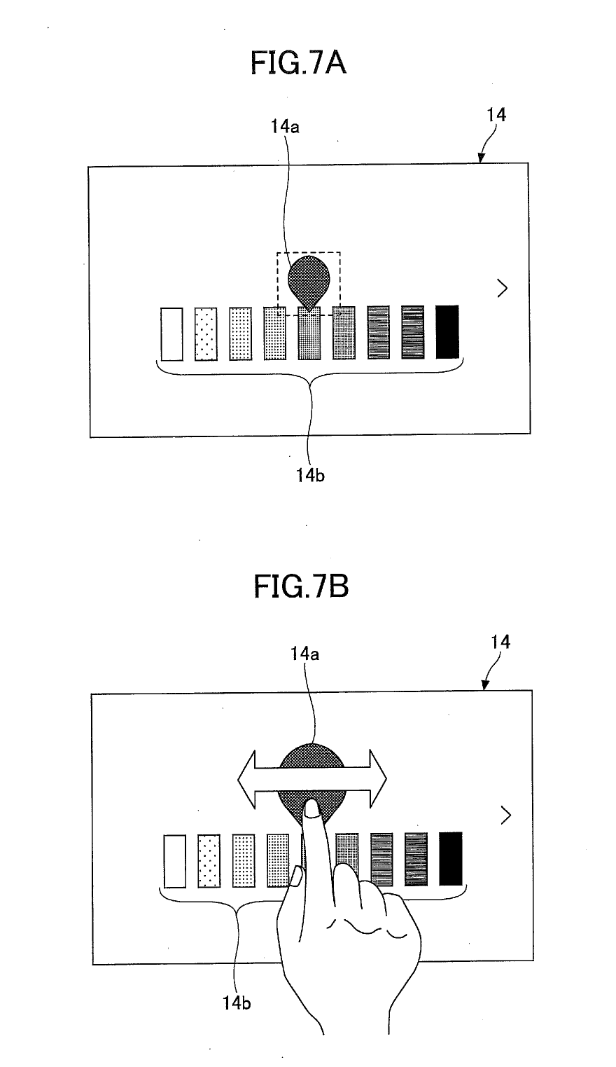

FIGS. 7A and 7B are drawings illustrating examples where a setting operation is performed using the setting component 14a of the display component 14 according to the first embodiment. FIG. 7A is a drawing illustrating the setting component 14a in detail, and FIG. 7B is a drawing illustrating where the enlarged image is displayed.

As illustrated in FIG. 7A, the setting component 14a according to the first embodiment is a component for setting the print density, which is operated though sliding along the multiple panels 14b indicating the level of the print density. The setting component 14a illustrated in FIG. 7A is displayed with a standard image.

According to the first embodiment, in a case where the setting component 14a is touched, the image of the setting component 14a is switched from the standard image to an enlarged image, as illustrated in FIG. 7B.

In the first embodiment, the image size of the setting components is switched as illustrated, so as to prevent the setting component 14a being hidden by the finger of a user.

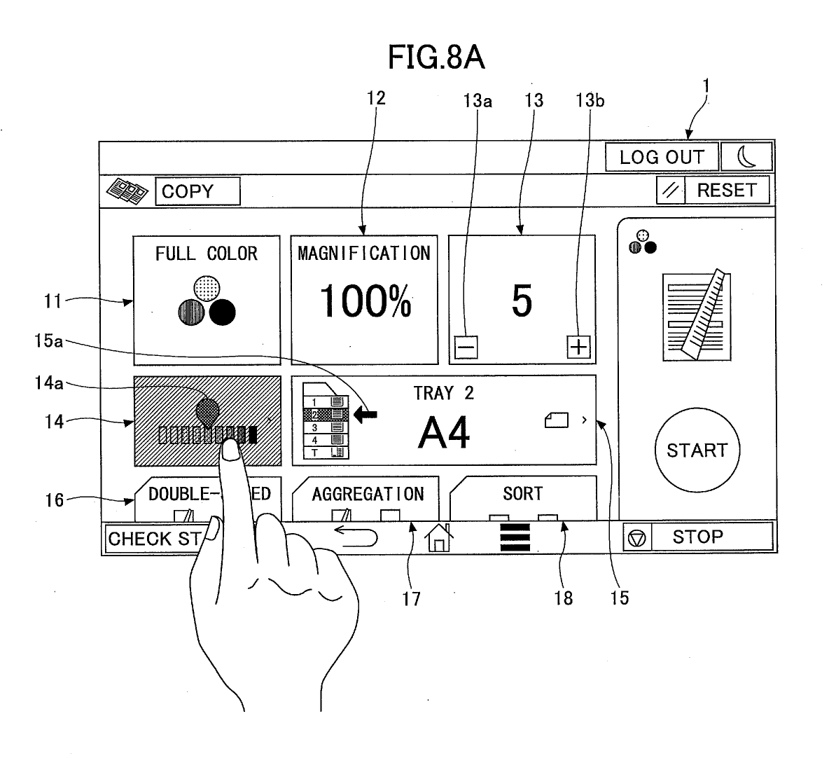

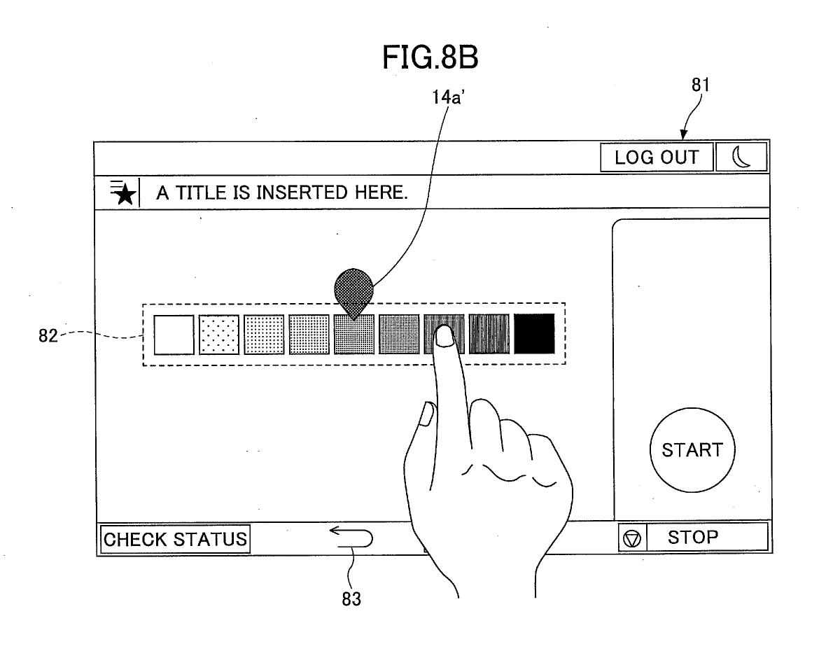

FIGS. 8A and 8B are drawings illustrating examples where the display component 14 is selected on the setting screen 1 according to the first embodiment. FIG. 8A illustrates where the display component 14 is selected on the setting screen 1. FIG. 8B illustrates an example of a detail setting screen 81.

In FIG. 8A, an operation is performed on the display component 14 in the region other than the setting component 14a. In this case, the display control processor 240 transitions the display of the operation panel 205 from the setting screen 1 to the detail setting screen 81 as illustrated in FIG. 8B. The detail setting screen 81 is for setting the print density, which is the item corresponding to the display component 14.

On the detail setting screen 81, a setting component 14a′ and multiple panels 82 are displayed. On the detail setting screen 81, in a case where one of the multiple panels 82 is selected, the position of the setting component 14a′ is moved to the position of the selected panel. Here, the image of the setting component 14a′ may be a standard image as displayed on the setting screen 1.

Furthermore, on the detail setting screen 81, in a case where a back button 83 is selected, the display control processor 240 transitions the display of the operation panel 205 from the detail setting screen 81 to the setting screen 1.

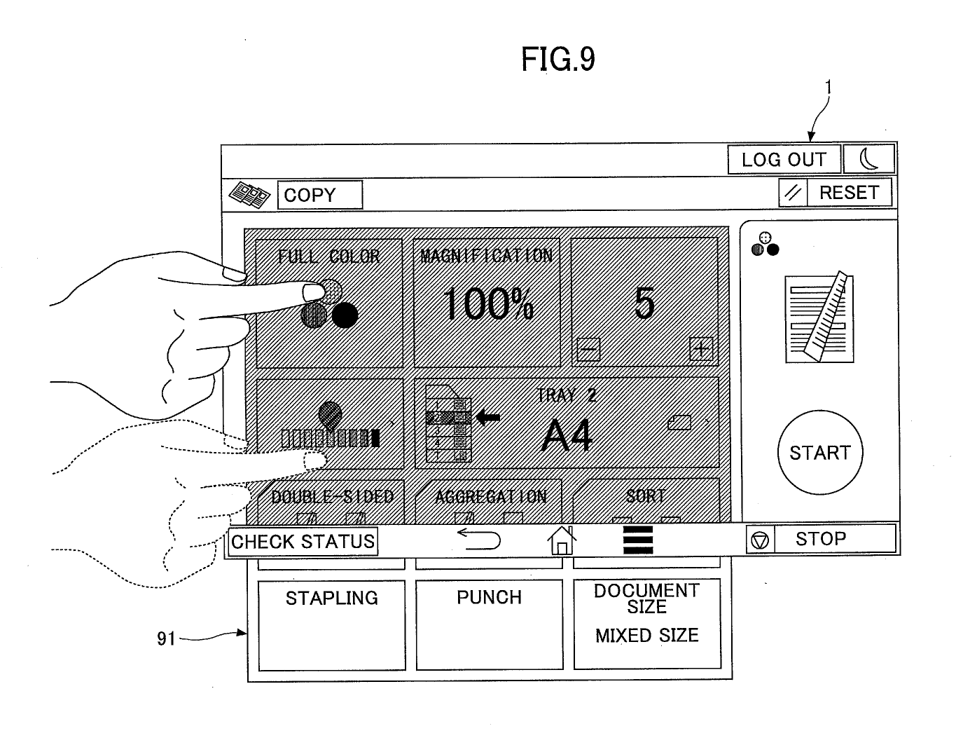

FIG. 9 is a drawing illustrating an example where a scrolling operation is detected on the setting screen 1 according to the first embodiment. In the first embodiment, in a case where a scrolling operation is detected in the region other than setting components on the setting screen 1, an image 91 displayed on the operation panel 205 is scrolled.

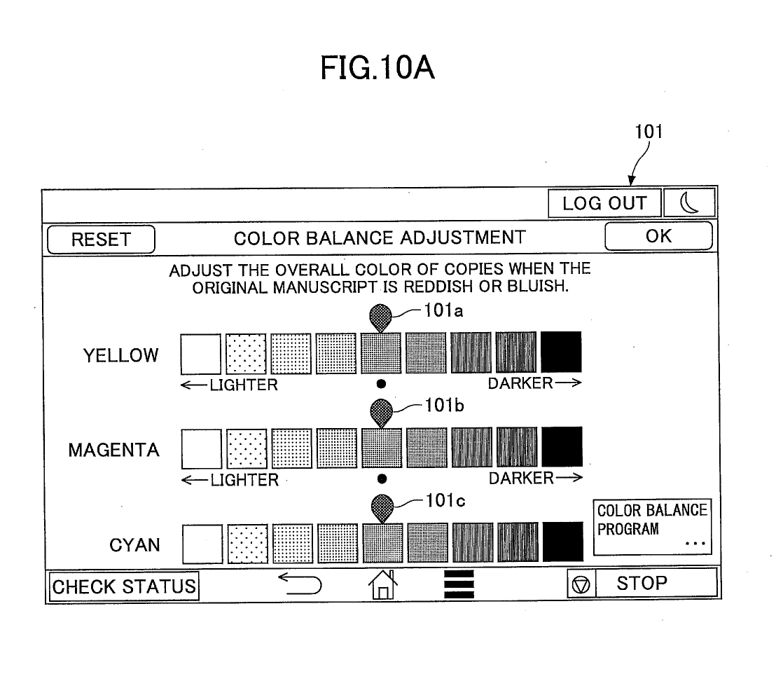

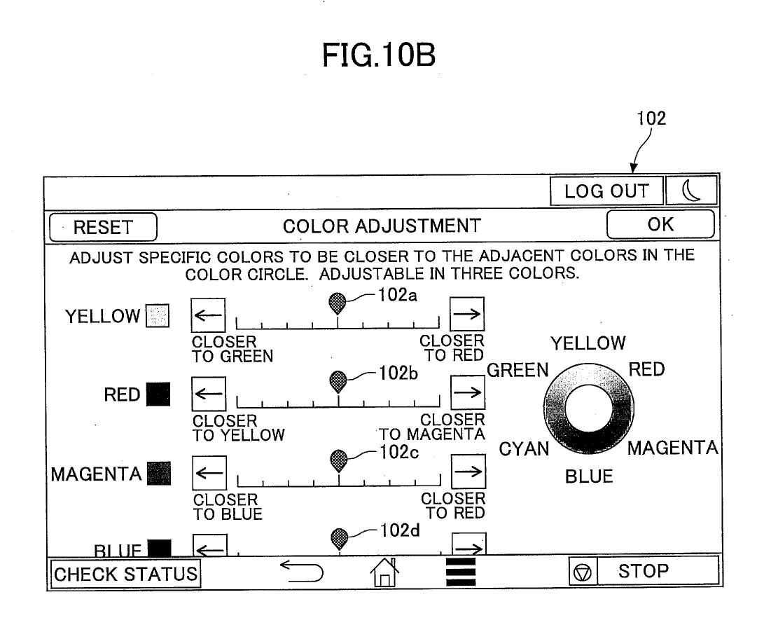

FIGS. 10A and 10B are drawings illustrating examples of detail setting screens 101 and 102. FIG. 10A is a drawing illustrating the first example of the detail setting screen 101 for setting the color balance, whereas FIG. 10B is a drawing illustrating the second example of the detail setting screen 102 for setting the color adjustment.

The detail setting screen 101 of the color balance as illustrated in FIG. 10A includes setting components 101a, 101b, and 101c, which correspond to respective each colors. On the detail setting screen 101, settings of the values of color densities responding to the setting components 101a, 101b, and 101c can be performed through sliding the respective setting components 101a, 101b, and 101c.

The detail setting screen 102 of the color adjustment as illustrated in FIG. 10B includes setting components 102a, 102b, and 102c, which correspond to respective each colors. On the detail setting screen 102, adjustments of colors corresponding to the setting components 102a, 102b, and 102c can be performed through sliding the setting respective components 102a, 102b, and 102c.

As described above, on the setting screen 1 according to the first embodiment having an overview of the setting items, in the case where a setting component for setting a value of an item is being operated, operations other than the operation directed to the setting component are not accepted. Therefore, according to the first embodiment, even though multiple display components are displayed on a single screen, an erroneous operation or an erroneous detection is prevented.

Furthermore, according to the first embodiment, settings of values can be performed on the setting screen 1 having an overview of the setting items, in other words, settings can be performed without displaying detail setting screens on the lower layer of the setting screen 1, which means the screen operability is improved.

### Second Embodiment

In the following, the second embodiment will be explained with reference to drawings. The second embodiment is different from the first embodiment in that, the setting screen 1 is scrolled in a case where a scrolling operation is performed on setting components. Therefore, in the description of the second embodiment, only the differences from the first embodiment will be explained. Further, elements having the same functional configurations as in the first embodiment are assigned with the same reference signs, so as to omit the explanations.

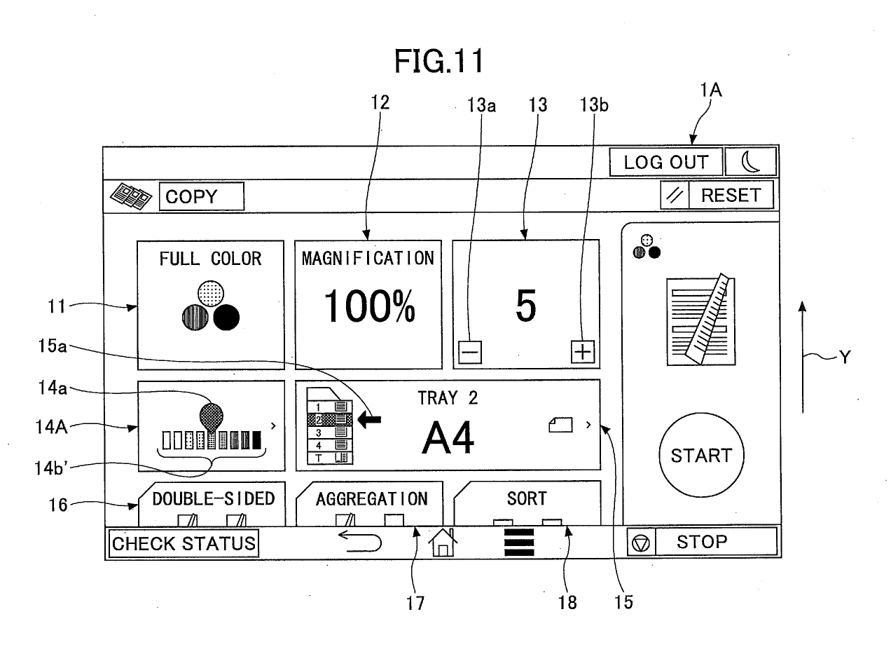

FIG. 11 is a drawing illustrating an example of a setting screen 1A according to the second embodiment. On the setting screen 1A according to the second embodiment, a display component 14A is displayed. The display component 14A is for setting the print density, and includes a setting components 14a and 14b′. The setting component 14b′ has multiple panels which indicate the level of the print density. Further, on the setting screen 14A, the setting for the print density can be performed through the setting component 14′.

Furthermore, on the setting screen 1A according to the second embodiment, in a case where a scrolling operation is performed in the region other than the displaying region of the setting components 14a and 14b′ while either of the setting components 14a and 14b′ is being touched, the scrolling operation is invalidated. Instead, on the setting screen according to the second embodiment, in a case where either of the setting components 14a and 14b′ is touched, and then the coordinate value of the touched position is moved in an upper or a lower direction, the operation is considered to be a scrolling operation, and therefore the setting screen 1A is scrolled.

That is to say, according to the second embodiment, when the setting components on the setting screen 1A is being touched, an scrolling operation performed in the region other than the displaying region of the setting components is restricted, whereas an scrolling operation performed in the displaying region of the setting components is accepted.

In other words, according to the second embodiment, in a case where an operation is performed on a setting component, a display control based on operations performed on the region other than the displaying region of the setting component is not accepted, whereas in a case where an operation is performed on a region other than the displaying region of setting components, a display control based on the operation is accepted.

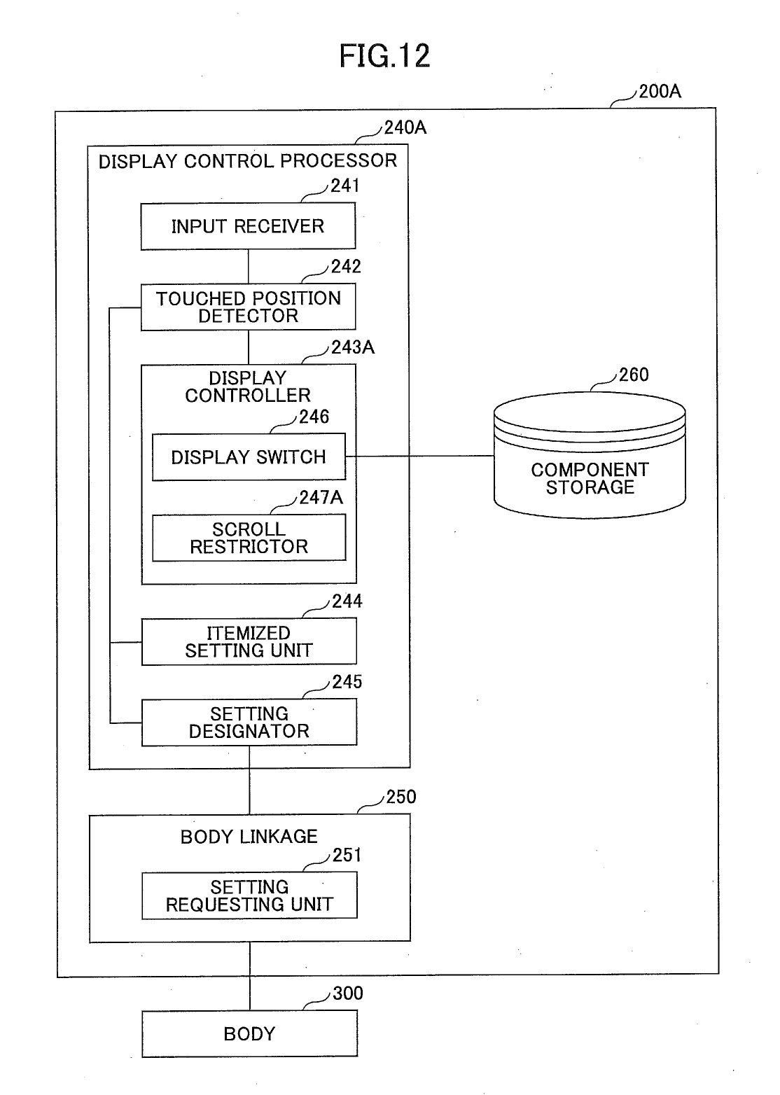

In the following, functions of an operator 200A according to the second embodiment will be explained. FIG. 12 is a drawing for explaining the functions of the operator 200A according to the second embodiment.

A display control processor 240A of the operator 200A according to the second embodiment includes a display controller 243A. The display controller 243A includes a scroll restrictor 247A.

In a case where an operation directed to a setting component is detected, the scroll restrictor 247A according to the second embodiment restricts scrolling operations performed in the region other than the displaying region of the setting component and accepts a scrolling operation performed in the displaying region of the setting component.

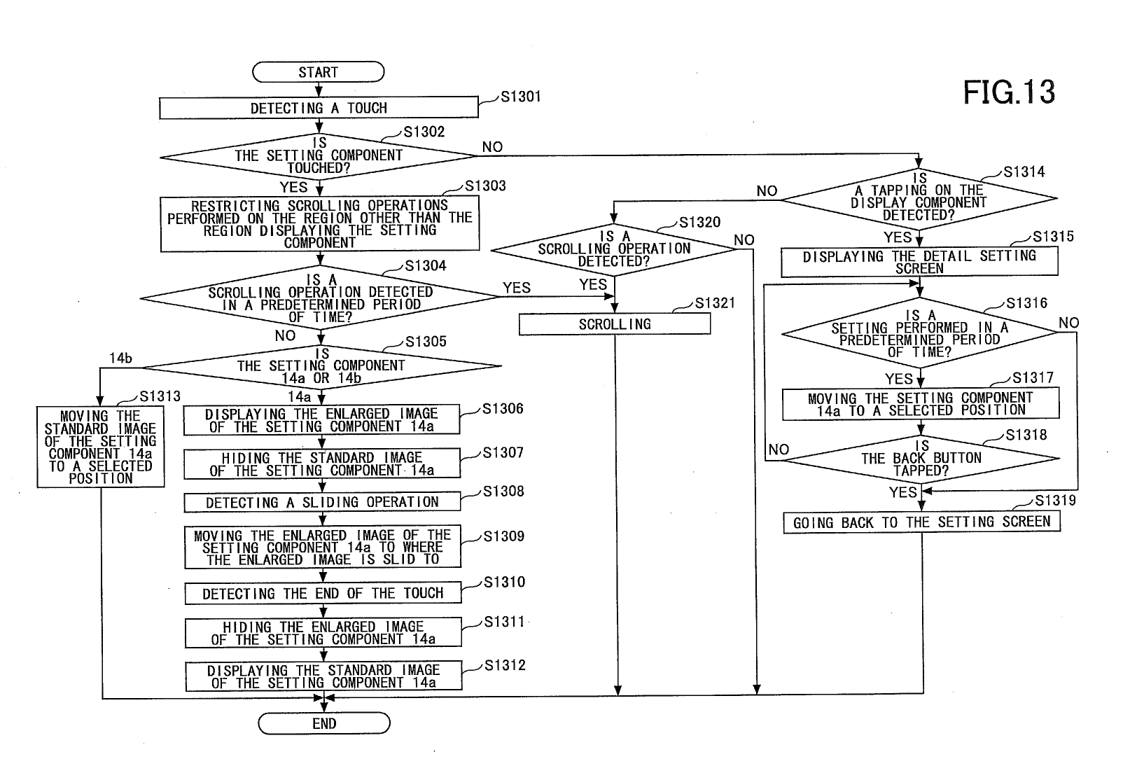

FIG. 13 is a flowchart for explaining the actions of the operator 200A according to the second embodiment. Here, FIG. 13 illustrates the actions when the setting of the print density is performed.

The processes of steps S1301 and S1302 of FIG. 13 are the same as steps S501 and S502 of FIG. 5, and therefore the explanations will be omitted.

In a case where a setting component is not touched in step S1302, the sequence proceeds to step S1314, which will be described later.

In a case where a setting component is touched in step S1302, the scroll restrictor 247A of the display control processor 240A restricts scrolling operations performed in the region other than the displaying region of the setting component detected to be touched (step S1303).

Subsequently, the touched position detector 242 of the display control processor 240A determines whether to detect a scrolling operation performed in the displaying region of the setting component in a predetermined period of time (step S1304). Specifically, the touched position detector 242 determines whether the coordinate value of the touched position in the displaying region of the setting component is changed in either an upper or a lower direction in the predetermined period of time.

In a case where a scrolling operation is detected in the predetermined period of time in step S1304, the display control processor 240A proceeds to step S1321, which will be described later.

In a case where an scrolling operation is not detected in the predetermined period of time in step S1304, the display control processor 240A determines the touched setting component is either the setting component 14a or 14b′ of the display component 14A (step S1305). Specifically, the display control processor 240A determines the coordinate value of the position detected by the touched position detector 242 is either in the display region of the setting component 14a or 14b′.

In a case where the determination result is the setting component 14a in step S1305, the display control processor 240A displays an enlarged image of the setting component 14a (step S1306), and hides the standard image of the setting component 14a (step S1307).

The processes of steps S1306 through S1312 of FIG. 13 are the same as steps S504 though S510 of FIG. 5, and therefore the explanations will be omitted.

In a case where the determination result is the setting component 14b′ in step S1305, the display control processor 240A moves the displaying position of the setting component 14a to the position of the selected panel of the setting component 14b′ (step S1313).

Furthermore, in a case where a setting component is not touched in step S1302, the display control processor 240A according to the second embodiment determines whether to detect a taping operation on the display components (step S1314).

The processes of steps S1314 through S1321 of FIG. 13 are the same as steps S511 though S518 of FIG. 5 except that the sequence proceeds to step S1321 in a case where a scrolling operation is detected in step S1304, and therefore the explanations will be omitted.

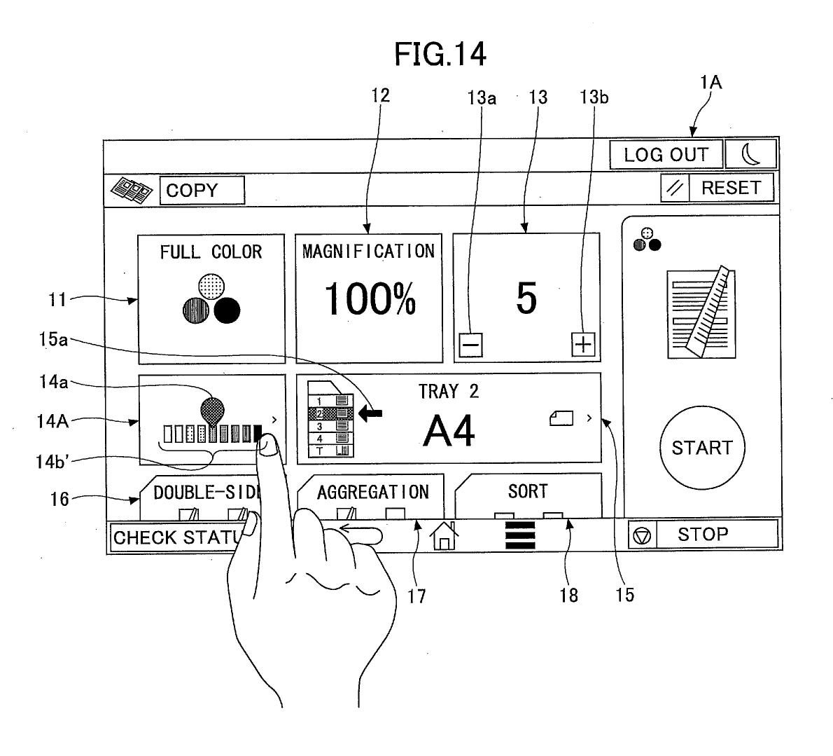

In the following, the process illustrated in FIG. 13 will be specifically explained, with reference to FIG. 14 through FIG. 17. FIG. 14 is a drawing illustrating an example where the setting component 14b′ is selected on the setting screen 1A according to the second embodiment.

In FIG. 14, an operation is performed on the setting component 14b′. According to the second embodiment, in FIG. 14, only operations performed on the displaying region of the setting component 14b′, including a scrolling operation of the setting screen 1A, are accepted.

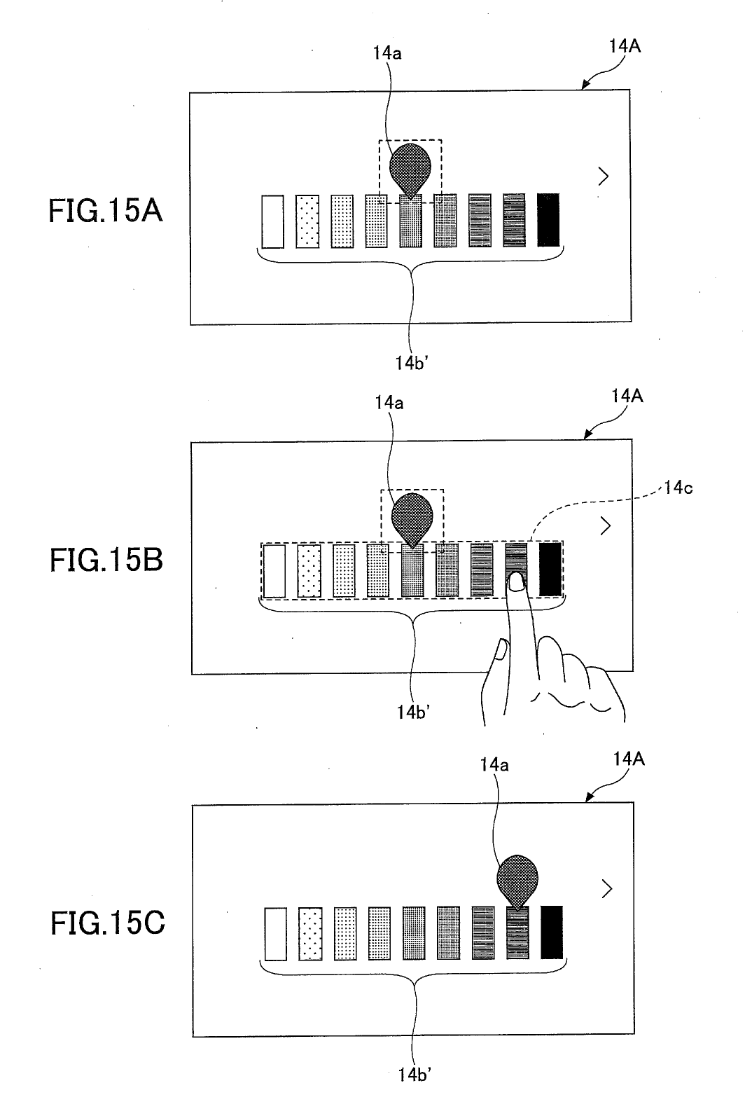

FIGS. 15A through 15C are drawings illustrating examples where a setting is performed using the setting component 14b′ of the display component 14A according to the second embodiment. FIG. 15A is a drawing illustrating the display component 14A. FIG. 15B is a drawing illustrating where a displaying region 14c of the setting component 14b′ is touched. FIG. 15C is a drawing illustrating where the displaying position of the setting component 14a is moved after the touching operation in FIG. 15B.

The images of the setting component 14a as illustrated in FIGS. 15A through 15C are standard images. According to the second embodiment, responding to a touching operation on the displaying region 14c of the setting component 14b′, the print density is set in accordance to the touched position.

In the second embodiment, responding to the touching operation on the panel close to the right edge among the panels of the setting component 14b′ (FIG. 15B), the display control processor 240A moves the displaying position of the standard image of the setting component 14a from the center as illustrated in FIG. 15A to the position of the touched panel.

Here, the displaying region 14c in the second embodiment includes the region between each of the panels of the setting component 14b′.

As described above, according to the second embodiment, the setting of the print density can be performed using setting component 14b′ displayed on the setting screen 1A, which consists of panels indicating the level of the print density. That is to say, according to the second embodiment, the user can perform settings of values of items using the most preferable way to the user.

Here, although the setting of the print density is exemplified in the second embodiment, the setting item is not limited to the print density. The second embodiment is applicable to any settings performed on a display component having a setting component which indicates the level of a setting item.

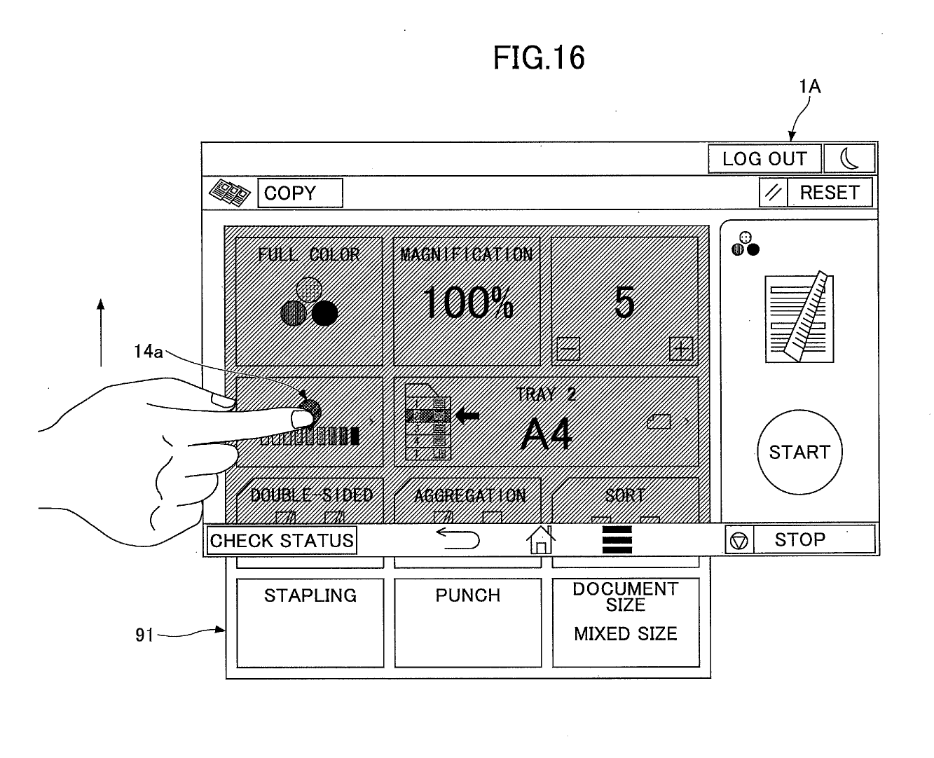

FIG. 16 is a drawing illustrating an example where a scrolling operation is detected on the setting screen 1A according to the second embodiment.

In FIG. 16, a scrolling operation is detected within the displaying region of the setting component 14a of the display component 14A while the setting component 14a is being touched.

Here, the scroll restrictor 247A of the display control processor 240A invalidates scrolling operations performed in the region other than the displaying region of the setting components 14a.

In response to a scrolling operation performed within the displaying region of the setting component 14a, the display control processor 240A scrolls the image 91 displayed on the operation panel 205.

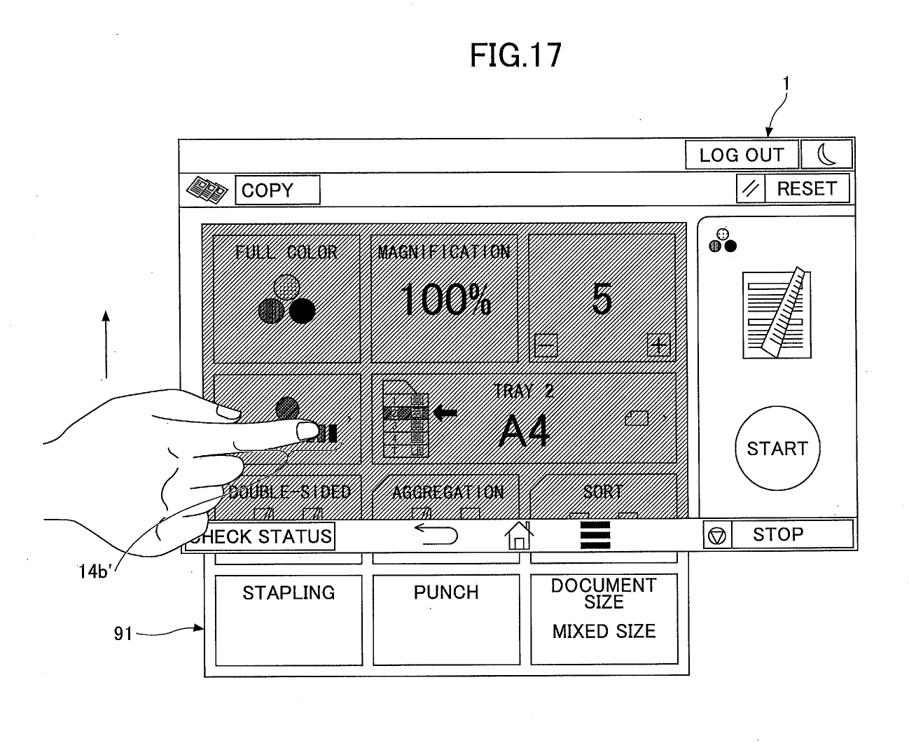

FIG. 17 is the second drawing illustrating an example where a scrolling operation is detected on the setting screen 1A according to the second embodiment.

In FIG. 17, a scrolling operation is detected within the displaying region of the setting component 14b′ of the display component 14A while the setting component 14b′ is being touched.

Here, the scroll restrictor 247A of the display control processor 240A invalidates scrolling operations performed in the region other than the displaying region of the setting components 14b′.

In response to a scrolling operation performed within the displaying region of the setting component 14b′, the display control processor 240A scrolls the image 91 displayed on the operation panel 205.

As described above, according to the second embodiment, while a setting component is being touched, operations performed within the displaying region of the setting component is accepted whereas operations performed in the region other than the displaying region of the setting component is not accepted.

In this way, according to the second embodiment, even in a case where a user mistakenly touches a setting component while the user is operating other setting component, the unintended operation is not accepted, and therefore the screen operability is enhanced.

Further, the present invention is not limited to these embodiments, but various variations and modifications may be made without departing from the scope of the present invention.

As described in the above description, screen operability can be improved.

What is claimed is:

1. An information processing apparatus comprising:
a display device;
a display controller configured to display a setting screen on the display device, the setting screen including a display component corresponding to a setting item and a setting component disposed inside the display component for a purpose of setting a value of the setting item;
a receiver configured to receive an operation performed on the setting screen; and
an execution controller configured, in a case where the receiver receives an operation performed outside the setting component, to perform a display control of the setting screen responding to the received operation, and configured, in a case where the receiver receives an operation performed on the setting component, not to perform a display control of the setting screen responding to another operation performed outside the setting component.

2. The information processing apparatus according to claim 1, wherein the operation performed outside the setting component is a scrolling operation.

3. The information processing apparatus according to claim 1, wherein the execution controller enlarges a size of the setting component in response to receiving the operation performed on the setting component.

4. The information processing apparatus according to claim 1, wherein the setting component is slid on the setting screen for the purpose of setting the value of the setting item.

5. The information processing apparatus according to claim 1,
wherein the receiver receives an operation performed outside the setting component but inside the display component, and
wherein, in response to receiving the operation performed outside the setting component but inside the display component, the display controller transitions the setting screen to a detail setting screen corresponding to the display screen.

6. The information processing apparatus according to claim 1, wherein the setting screen includes a plurality of display components each corresponding to a setting item.

7. An image processing apparatus comprising:
a display device;
a display controller configured to display a setting screen on the display device, the setting screen including a display component corresponding to a setting item and a setting component disposed inside the display component for a purpose of setting a value of the setting item;
a receiver configured to receive an operation performed on the setting screen; and
an execution controller configured, in a case where the receiver receives an operation performed outside the setting component, to perform a display control of the setting screen responding to the received operation, and configured, in a case where the receiver receives an operation performed on the setting component, not to perform a display control of the setting screen responding to another operation performed outside the setting component.

8. The image processing apparatus according to claim 7, wherein the operation performed outside the setting component is a scrolling operation.

9. The image processing apparatus according to claim 7, wherein the execution controller enlarges a size of the setting component in response to receiving the operation performed on the setting component.

10. The image processing apparatus according to claim 7, wherein the setting component is slid on the setting screen for the purpose of setting the value of the setting item.

11. The image processing apparatus according to claim 7,
wherein the receiver receives an operation performed outside the setting component but inside the display component, and
wherein, in response to receiving the operation performed outside the setting component but inside the display component, the display controller transitions the setting screen to a detail setting screen corresponding to the display screen.

12. The image processing apparatus according to claim 7, wherein the setting screen includes a plurality of display components each corresponding to a setting item.

13. A computer-readable storage medium storing a program for causing a computer to execute a process, the process comprising:
displaying a setting screen on a display device, the setting screen including a display component corresponding to a setting item and a setting component disposed inside the display component for a purpose of setting a value of the setting item;
receiving an operation performed on the setting screen; and
performing, in a case where the receiver receives an operation performed outside the setting component, a display control of the setting screen responding to the received operation, and not performing, in a case where the receiver receives an operation performed on the setting component, a display control of the setting screen responding to another operation performed outside the setting component.

14. The computer-readable storage medium according to claim 13, wherein the operation performed outside the setting component is a scrolling operation.

15. The computer-readable storage medium according to claim 13, wherein the execution controller enlarges a size of the setting component in response to receiving the operation performed on the setting component.

16. The computer-readable storage medium according to claim 13, wherein the setting component is slid on the setting screen for the purpose of setting the value of the setting item.

17. The computer-readable storage medium according to claim 13,
wherein the receiver receives an operation performed outside the setting component but inside the display component, and
wherein, in response to receiving the operation performed outside the setting component but inside the display component, the display controller transitions the setting screen to a detail setting screen corresponding to the display screen.

18. The computer-readable storage medium according to claim 13, wherein the setting screen includes a plurality of display components each corresponding to a setting item.
